(19) United States
(12) Patent Application Publication
(10) Pub. No.: US 2026/0356184 A1
(43) Pub. Date: Nov. 12, 2026

(54) HYBRID ELECTRIC DRIVE SYSTEM FOR A VEHICLE

(71) Applicant: NEXTGEN TECH INITIATIVES PVT LTD, Thane West (IN)

(72) Inventors: Rohit Arvind GODKAR, Thane West (IN); Mehul Satish NACHANE, Thane West (IN); Sharad Rajaram GODKAR, Mumbai (IN)

(21) Appl. No.: 19/647,193

(22) Filed: Apr. 14, 2026

(30) Foreign Application Priority Data
Apr. 16, 2025 (IN) 202523036903

(51) Int. Cl. B60K 6/48; B60K 6/365; B60K 6/387; B60K 6/52; B60K 23/08; B60K 25/00; B60K 25/02; B60L 7/10; F16H 61/28; F16H 61/30; F16H 63/30

(52) U.S. Cl. CPC B60K 6/48; B60K 6/365; B60K 6/387; B60K 6/52; B60K 23/08; B60K 25/02; B60L 7/10; F16H 61/2807; F16H 61/30; F16H 63/3003; B60K 2025/005; B60K 2025/022; B60Y 2200/92; B60Y 2400/112; B60Y 2400/424; B60Y 2400/73; B60Y 2400/82; F16H 2063/3006

(57) ABSTRACT

A retro-fittable hybrid electric drive system (106) comprises an electric motor (108) and a hybrid drivetrain assembly (110), and is configured between IC power pack (500) and the rear axle of a vehicle to allow different modes of operations, comprising an IC engine mode, an electric mode, a combined mode and a generative mode. The epicyclic gear system (130) and mode controller mechanism (140) comprises a electrically operated eccentric and rocker mechanism (340) to lock or unlock different elements of the epicyclic gear train to achieve the different modes of operations, including two different forward torque-speed ratios during the electric mode.

### FIELD

Present invention relates to the field of automobiles. In particular, the present disclosure pertains to an alternative powertrain technology that optimizes integration of two independent drives such as ICE and Electric powertrains, on a vehicle.

### BACKGROUND

Background description includes information that may be useful in understanding the present invention. It is not an admission that any of the information provided herein is prior art or relevant to the presently claimed invention, or that any publication specifically or implicitly referenced is prior art.

One of the greatest challenges being faced by human race today is undoubtedly the climate change and its potentially catastrophic consequences for humanity. The ever-rising greenhouse gas emissions coupled with massive urbanization trends create a further challenge where large scale migration to urban areas is creating several high density population clusters that require tremendous resources for survival such as round the clock availability of utilities, products and services to support such urban lifestyle. As a consequence, one of the highest contributors to global greenhouse gas emissions is transportation sector, responsible for nearly quarter of greenhouse gas emissions every year. The urban vehicular emissions not only affect the global temperature rise and the climate, but also the health of the urban populations as they inhale those harmful vehicular emissions that create health hazards including early deaths and COPD (chronic obstructive pulmonary disorders).

There has been a strong scientific evidence and record of such health hazards and ailments which need to be addressed with the sense of urgency, by providing more workable solutions for sustainable mobility which reduces the quantum of harmful emissions. At the same time, the consumers of automobile sector are used to certain conveniences with respect to ease of fueling, long range on a full fuel tank, as well as certain driving features which can't be taken away from them in an instant by switching to non-IC engine vehicles such as fully electric vehicles, which are short on features and conveniences keeping in mind the mass affordability factor. The fully electric vehicles have several shortcomings such as long recharge times, inconvenience of not having adequate charging facilities, range anxiety for drivers and passengers as a result of relatively short range on a single charge, etc.

Therefore, there is a need to first migrate to an intermittent stage of hybrid electric mobility solution such as a Plug-in Hybrid Electric Vehicle (PHEV) and/or Fuel Cell Electric Hybrid Vehicle (FC-HEV) whereby all shortcomings of a full electric vehicle or an ICE vehicle, can be effectively addressed.

### OBJECTS OF THE DISCLOSURE

Some of the objects of the present disclosure, which at least one embodiment herein satisfies are as listed herein below.

It is an object of the present invention to provide a hybrid drive system for an internal combustion (IC) engine based vehicle, the hybrid drive system enables (i) quick, cost-effective and easy conversion of existing Internal Combustion Engine (ICE) vehicles into their Plug-in Hybrid Electric Vehicle (PHEV) variants, (ii) production of new Plug-in Hybrid Electric Vehicles (PHEVs) and (iii) an option to convert such Plug-in Hybrid Electric Vehicles into zero-tailpipe Full Electric Vehicles (EVs) in a sustainable and phased manner thereby providing a more inclusive and sustainable mobility solution.

It is another object of the present invention to provide a hybrid drive system that can be fitted on manufacturer's assembly line to new vehicles being manufactured using the existing ICE vehicle architecture and platform thereby easily making those into Plug-in Hybrid Electric Vehicles (PHEVs) in a quick and cost effective manner.

It is another object of the present invention to provide a hybrid drive system that can be retrofitted to convert an existing on-road vehicle powered by an ICE based power pack to a PHEV without modifying the vehicle's architecture and platform thereby providing a solution that can be easily accommodated in a constrained design space of an existing on-road vehicle.

It is another object of the present invention to provide a hybrid drive system that can be easily installed on a rear wheel drive vehicle or an all-wheel drive vehicle.

It is another object of the present invention to provide a mode controller mechanism in the hybrid drive system that enables selection of various driving modes (Electric Mode, IC engine mode or combined mode) and their combinations in order to propel the vehicle by using a programmable logic controller based on the vehicle's speed and load.

It is another object of the present invention to provide a compact, fail-safe and easy to operate mode controller mechanism in the hybrid drive system that can enable different driving modes of the hybrid drive system.

It is another object of the present invention to have an AI (Artificial Intelligence) based control system for the vehicle that can on the basis of the road conditions, traffic conditions, vehicular emission restrictions and route selected by the driver, select the various driving modes (Electric Mode, IC engine mode or combined mode) and their combinations in order to propel the vehicle by using the best efficiency operating zones of either of the powertrains.

It is another object of the present invention to provide a hybrid drive system that allows one or more gear ratios and thereby allowing multiple torque-speed characteristics from the electric drive as well.

It is another object of the present invention to allow the option of power take-off (PTO) to be provided from the electric powertrain of a hybrid electric vehicle.

### SUMMARY

Present invention relates to hybrid drive system that optimizes integration of two independent drives such as ICE and Electric powertrains, on a vehicle. More particularly, the present invention relates to a hybrid drive system that can quickly enable a cost-effective and sustainable conversion of an IC engine vehicle into its plug-in hybrid electric vehicle variant and then into a full electric vehicle variant in a phased manner. The hybrid drive system can be integrated with both existing vehicles on-road and newly manufactured vehicles that operate on an internal combustion engine based power pack (ICE power pack, herein) thereby converting those into PHEVs that offer an optimum sustainable mobility solution. Specifically, the disclosed hybrid drive system can be integrated on rear wheel drive vehicles or all-wheel drive vehicles.

In an aspect, the disclosed hybrid drive system is configured between the IC engine gearbox and the rear axle of the vehicle and such hybrid drive system includes an electric motor, a hybrid drivetrain assembly and a common output driveshaft through which the power from the hybrid drive system is given to an axle of the vehicle and further to the set of wheels. The hybrid drive system provides three different driving modes. The three independent driving modes include: drive to the axle from the primary ICE power pack, drive to the axle from the Electric Motor, and drive to the axle collectively from the ICE power pack and the Electric Motor.

In an aspect, the hybrid drivetrain assembly comprises an epicyclic geartrain assembly and a mode controller mechanism that can provide the necessary engagement and disengagement of the electric motor drive with the ICE power pack to enable the different driving modes. The hybrid drivetrain assembly also provides for multiple torque-speed ratios from the electric motor drive.

In an aspect, the mode controller mechanism comprises at least one of a pair of control levers that move to different positions, a multi-plate clutch arrangement and a band brake system to enable locking and unlocking of at least one of the planet carrier, the ring gear and the sun gear of the epicyclic geartrain assembly for enabling the single or multiple torque-speed ratios during the drive from the electric motor in a pure electric mode or in a combined mode of operation and the IC engine driving mode.

In an aspect, the mode controller mechanism of the hybrid drivetrain assembly comprises an electrically operated eccentric and rocker mechanism moves the pair of control levers to different positions to enable the different driving modes.

In an aspect, the hybrid drive system is configured in a rear wheel drive vehicle or an all-wheel drive vehicle. The hybrid drive system can be configured between the IC engine gearbox and the rear axle of the vehicle.

In an aspect, the hybrid drivetrain assembly allows output to be taken from a sun gear of the epicyclic geartrain assembly and input to be given to at least one of planet carrier or a ring gear of the epicyclic geartrain.

In an aspect, the power from both the ICE power pack and the electric motor is transmitted to the sun gear such that the sun gear transmits the power to the common output driveshaft and hence to an axle of the vehicle.

In an aspect, hybrid drivetrain assembly comprises a first series of pinion gears that transmit electric motor power to the planet carrier of the epicyclic gear system and a second series of pinion gears that transmit electric motor power to the ring gear of the epicyclic geartrain.

In an aspect, the mode controller mechanism consisting of the control levers comprises locking pinion gears that are mounted on the control levers that move to different positions. The first locking pinion gear locks and unlocks the ring gear and a second locking pinion gear locks and unlocks the planet carrier of the epicyclic geartrain based upon the required operation to enable the different driving modes.

In an aspect, the electrically operated eccentric and rocker mechanism of the mode controller comprises a pair of rocker arms that are connected to the control levers. A shaft is provided that has eccentrics on which are mounted the pair of rocker arms. An electric motor rotates the shaft and an electric actuator is also provided that can lock and prevent rotation of the shaft. On receiving the necessary command signal for changing the driving modes from the programmable logic controller, the electric motor rotates the shaft in the desired direction such that the rotation of the eccentrics causes the rockers to move the control levers to different positions to enable the different driving modes. The electric actuator locks the shaft and prevents it from rotating once the desired position of the control levers is achieved. The desired signal for the electric actuator is also given by the programmable logic controller. The design of the eccentrics is such that it ensures that no more than one element of the epicyclic geartrain assembly can be locked at a time.

In an aspect, for the electric mode, the planet carrier of epicyclic geartrain is unlocked, the electric motor power is transmitted to the planet carrier through a first series of pinion gears of the epicyclic geartrain and mode controller, and the ring gear is locked such that, the power from the electric motor is sent through the epicyclic geartrain to the common output driveshaft and the electric mode is enabled.

In an aspect, for a second gear ratio in electric mode, the ring gear of the epicyclic geartrain is unlocked, the electric motor power is transmitted to the ring gear through the second series of pinion gears of the epicyclic geartrain and mode controller and the planet carrier is locked such that, the power from the electric motor is sent through the epicyclic geartrain to the common output driveshaft and the second torque speed gear ratio in electric mode is enabled.

In an aspect, for the IC engine mode, the planet carrier of the epicyclic geartrain is unlocked with the electric motor being switched off and the ring gear of the epicyclic geartrain is also unlocked such that, the power from the IC engine powerpack is sent to the common output driveshaft and the IC engine mode is enabled.

In an aspect, for combined mode, the planet carrier of the epicyclic gear train is unlocked, power from the electric motor is transmitted to the planet carrier, and the ring gear is locked or unlocked such that unlocking of the ring gear allows the sun gear to adjust to the power being transmitted from both IC engine power pack and electric motor.

In an embodiment, the mode controller mechanism of the hybrid drivetrain assembly can comprise of a first multi-plate clutch arrangement that locks and unlocks ring gear of the epicyclic geartrain assembly and a second multi-plate clutch arrangement that locks and unlocks the planet carrier of the epicyclic geartrain assembly enabling the single or multiple torque-speed ratios during the drive from the electric motor in a pure electric mode or in a combined mode of operation and the IC engine driving mode. The first multi-plate clutch arrangement and second multi-plate clutch arrangement is operated using at least one of the hydraulic mechanism, the linkage mechanism and an electro-magnetic arrangement.

In an embodiment, the hybrid drivetrain assembly may include a programmable logic operatively coupled to provide signals to a hydraulic mechanism or an electro-magnetic arrangement, thereby enabling the different driving modes.

In an embodiment, the hybrid drivetrain assembly may include a mechanical cable operated assembly coupled that is operatively coupled to a linkage mechanism, to enable different driving modes.

In an embodiment, the mode controller of the hybrid drivetrain assembly comprises a first band brake system that locks and unlocks ring gear, and a second band brake system that locks and unlocks the planet carrier of the epicyclic geartrain based upon the required operation to enable the different driving modes.

In an embodiment, each of the band brake system comprises of the brake band, the hub connected to the gear and a bell crank lever. A spring-loaded plunger locking arrangement operated by a cable system enables the bell crank lever to move in the desired location to tighten or loosen the band on the hub to lock or unlock the respective gear based upon the required operation to enable the different driving modes.

In an embodiment, the hybrid drive system may further enable a regeneration mode that allows a transfer of power from sun gear to planet carrier with the ring gear locked or unlocked, thereby resulting in different levels of regeneration to allow a battery pack to be recharged, depending on the state of charge.

In an embodiment, the hybrid drivetrain assembly may include more than one epicyclic geartrain assembly thereby enabling multiple torque speed gear ratios in the electric mode.

In an aspect, a power take-off (PTO) option can be provided from the electric powertrain of a hybrid electric vehicle allowing utility trucks, commercial vehicles and tractors to use the PTO option to derive auxiliary power to operate accessories like mowers, water pumps, compressors, etc. Using the present invention such a PTO option can be used even while keeping the IC engine shut off, thereby having zero tailpipe emissions while being in the residential areas, urban areas, city centers or enclosed spaces.

An aspect of the present disclosure relates to a vehicle that includes a transfer case with a four-wheel drive or all-wheel drive option comprising the disclosed hybrid drive system.

An aspect of the present disclosure relates to a vehicle wherein the hybrid drive system enables—(i) conversion of IC engine vehicle into its plug-in hybrid electric vehicle variant or (ii) a production of a new plug-in hybrid electric vehicle wherein the IC engine is powered by at least one type of fuel such as diesel, petrol, CNG, LNG, ethanol and hydrogen and wherein the electrical energy to operate the electric motor is provided by at least one energy source such as a battery, a hydrogen fuel cells stack and an arrangement of ultra-capacitors.

An aspect of the present disclosure relates to a vehicle wherein the hybrid drive system in a constrained design space of the prevalent ICE vehicle architecture enables conversion of the on-road ICE vehicle into its plug-in hybrid electric vehicle variant and then into a full electric vehicle variant in a phased manner.

An aspect of the present disclosure relates to a vehicle that includes an AI (Artificial Intelligence) based control system. Such a control system on the basis of the road conditions, traffic conditions, vehicular emission restrictions and route selected by the driver, aids the driver by selecting an appropriate driving mode-whether Electric Mode, IC engine mode or combined mode and their combinations thereby ensuring to propel the vehicle by using the best efficiency operating zones of either of the powertrains.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIG. 1A illustrates an implementation of an electric mode in a vehicle, in accordance with an embodiment of the present disclosure.

FIG. 1B illustrates an implementation of an engine mode in the vehicle, in accordance with an embodiment of the present disclosure.

FIG. 1C illustrates an implementation of a combined mode in the vehicle, in accordance with an embodiment of the present disclosure.

FIG. 1D illustrates an implementation of a regeneration mode in the vehicle, in accordance with an embodiment of the present disclosure.

FIGS. 2A, 2B & 2C illustrates an exemplary architecture of Hybrid Drive System in the vehicle, in accordance with an embodiment of the present disclosure.

FIG. 3 illustrates the hybrid drive system from engine side, in accordance with an embodiment of the present disclosure.

FIGS. 4A & 4B illustrates the hybrid drivetrain assembly comprising the epicyclic gear train and mode controller mechanism seen from engine side and electric motor side respectively, in accordance with an embodiment of the present disclosure.

FIGS. 4C & 4D illustrates the hybrid drivetrain assembly comprising the epicyclic gear train and mode controller mechanism with the electric eccentric and rocker mechanism seen from engine side and electric motor side respectively, in accordance with an embodiment of the present disclosure.

FIG. 4E illustrates the detailed view of the shaft with eccentrics used in the electrically operated eccentric and rocker mechanism, in accordance with an embodiment of the present disclosure.

FIG. 4F illustrates the hybrid drivetrain assembly comprising the epicyclic gear train and mode controller mechanism for a two-speed torque ratio system from motor side in conjunction with a Power Take-Off (PTO) mechanism, in accordance with an embodiment of the present disclosure.

FIG. 4G illustrates the hybrid drivetrain assembly comprising the epicyclic gear train and mode controller mechanism for an all-wheel drive or four-wheel drive vehicle, in accordance with an embodiment of the present disclosure.

FIGS. 5A & 5B illustrates the hybrid drivetrain assembly comprising the multi-plate clutch mechanism used in the mode controller mechanism seen from engine side and electric motor side respectively, in accordance with an embodiment of the present disclosure.

FIGS. 5C & 5D illustrates the exploded or detailed view of the multi-plate clutch mechanism used in the mode controller mechanism, in accordance with an embodiment of the present disclosure.

FIG. 5E illustrates the various multi-plate clutch mechanism actuation systems used in the mode controller mechanism, in accordance with an embodiment of the present disclosure.

FIG. 6 illustrates the hybrid drivetrain assembly comprising the band brake system used in the mode controller mechanism, in accordance with an embodiment of the present disclosure.

FIG. 7A illustrates an exemplary representation depicting working of the hybrid drivetrain assembly in the electric mode, in accordance with an embodiment of the present disclosure.

FIG. 7B illustrates an exemplary representation depicting working of the hybrid drivetrain assembly in the second ratio for electric mode, in accordance with an embodiment of the present disclosure.

FIG. 7C illustrates an exemplary representation depicting working of the hybrid drivetrain assembly in the combined mode, in accordance with an embodiment of the present disclosure.

FIGS. 8A and 8B illustrates the Power Take-Off option driven by the electric powertrain in a hybrid electric vehicle.

FIG. 9 illustrates an exemplary representation of a combined accelerator of the hybrid drive system, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Systems depicted in some of the figures may be provided in various configurations. In some embodiments, the systems may be configured as a distributed system where one or more components of the system are distributed across one or more networks in a cloud computing system.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims.

Various terms as used herein are shown below. To the extent a term used in a claim is not defined below, it should be given the broadest definition persons in the pertinent art have given that term as reflected in printed publications and issued patents at the time of filing.

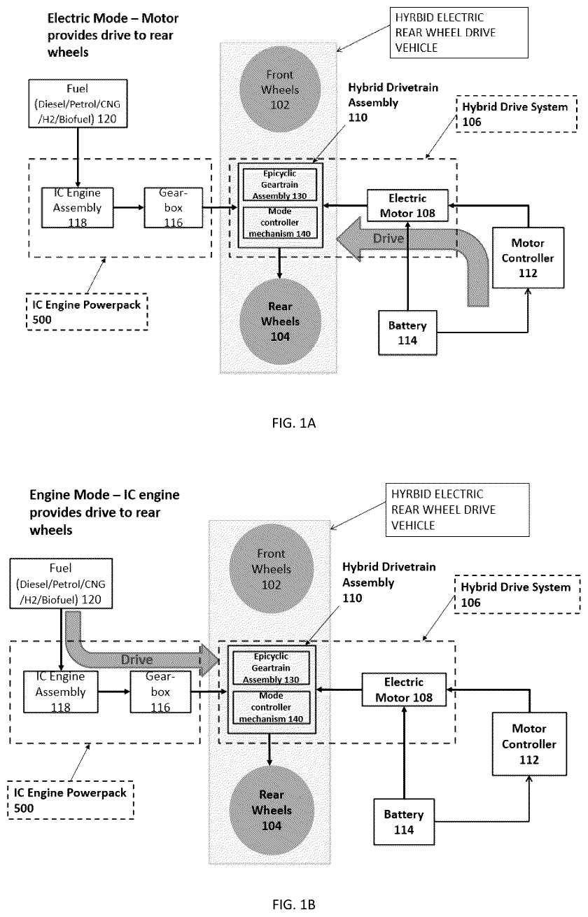

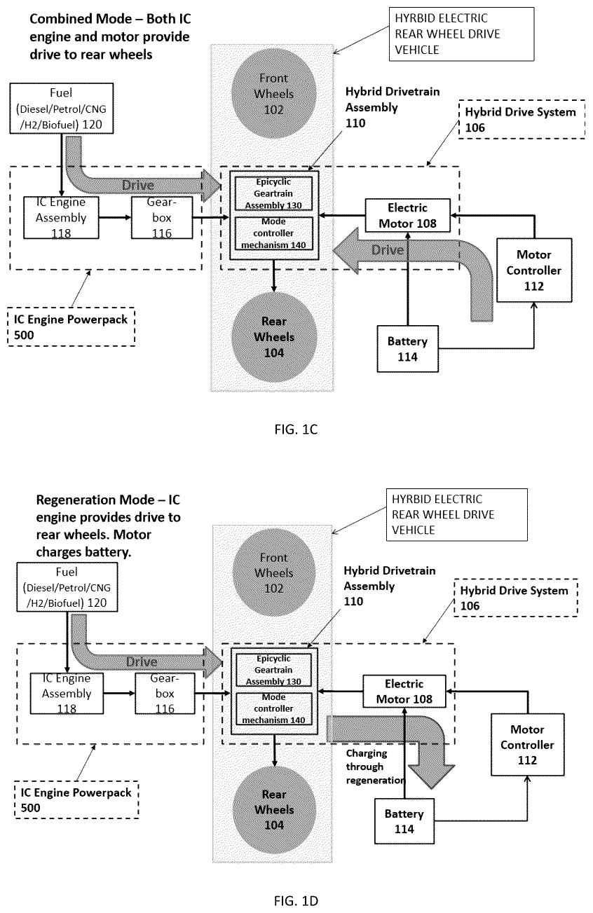

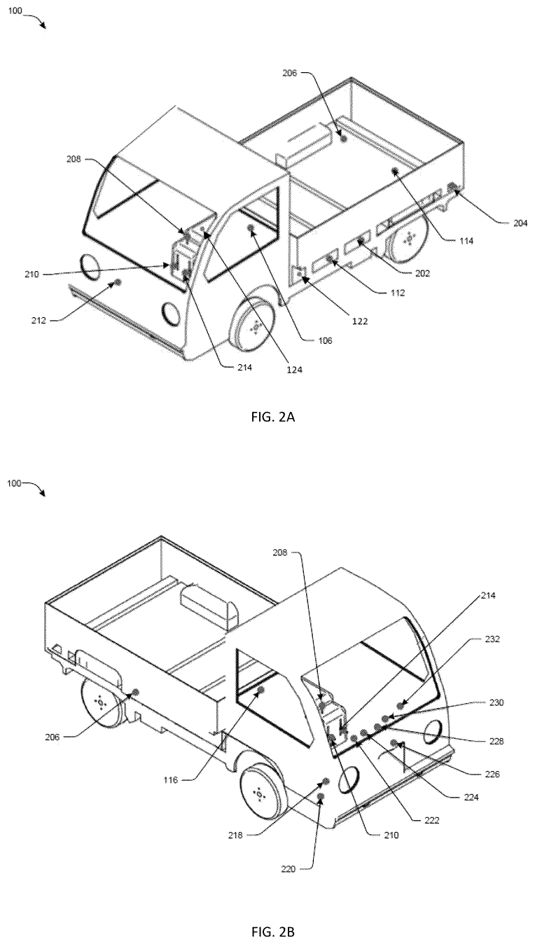

FIG. 1A illustrates an implementation of the disclosed hybrid drive system on a vehicle showing operation in an electric mode, in accordance with an embodiment of the present disclosure.

According to an embodiment, a hybrid drive system 106 is implemented in a vehicle 100. The hybrid drive system 106 includes an electric motor 108 and a hybrid drivetrain assembly 110. The vehicle 100 includes an IC power pack 500 having an internal combustion (IC) engine assembly 118 and a gearbox assembly 116, supplying power to rear wheels 104 of rear axle of the vehicle. The vehicle further includes a battery 114 to supply electric power to the electric motor 108, a motor controller 112 and a fuel unit 120 to supply fuel to the IC engine 118.

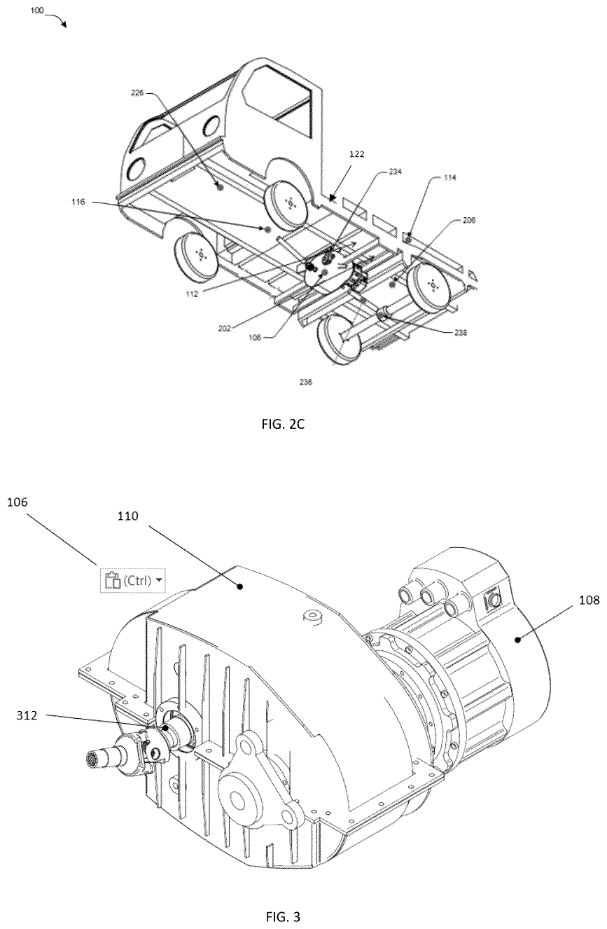

In an embodiment, the hybrid drivetrain assembly 110 of the hybrid drive system 106 includes an epicyclic (also interchangeably known as “planetary”) gear train 130 and mode controller mechanism 140, which facilitates in utilizing the torque generated from both the electric motor 108 and the IC engine assembly 118 either independently or in a combined way. The hybrid drive system 106 provides seamless synchronization of the IC engine drive and the electric drive by taking it from the IC power pack 500 and the electric motor 108. Further, the added or individual drives are transmitted to the common drive shaft 236 (refer to FIG. 2A) of the vehicle 100 and from there on to the final driven axle. The technical specification of the electric drive that includes the electric motor 108 capacity, the related gear ratios of the epicyclic gear system 130 and the battery capacity can be customized as per the vehicle requirements and the user's preferences.

In an embodiment, FIG. 1B illustrates an implementation of the disclosed hybrid drive system on a vehicle showing operation in an IC engine mode, where the IC engine assembly 118 of the IC power pack 500 provides the drive to the axle through the epicyclic gear train 130 of the hybrid drivetrain assembly 110.

In an embodiment, FIG. 1C illustrates an implementation of the disclosed hybrid drive system on a vehicle showing operation in combined mode, where both the electric motor 108 and the IC engine assembly 118 of the IC power pack 500 provides the drive to the axle through the epicyclic gear train 130 of the hybrid drivetrain assembly 110.

In an embodiment, FIG. 1D illustrates an implementation of the disclosed hybrid electric drive system on a vehicle showing operation in a regeneration mode, where the electric motor 108 acts as a generator and charges the battery 114, while the vehicle 100 may be driven by the IC engine assembly 118. Even during braking, the electric motor 108 can act as a generator and recharge the battery 114.

In another embodiment, the present invention includes an energy recuperation system that makes innovative use of mechanical power transfer from different elements of the hybrid electric drive system 106 to result in varying levels of regeneration current being fed back into the battery 114 when the vehicle 100 is decelerating or there is a need to apply brakes.

In an embodiment, the hybrid electric drive system 106 is based on the fact, that the existing internal combustion engine powerpack 500 is kept unaltered till the output of the IC engine gearbox 116. Further, the hybrid drive system 106 which includes the electric motor 108 and the hybrid drivetrain assembly 110, can be added between the gearbox 116 of the IC power pack 500 and a rear axle differential final drive unit 238. Both the IC engine 118 and electric motor 108 power is transmitted by a common output driveshaft 236 to the rear axle differential and then to the rear wheels 104.

FIGS. 2A, 2B and 2C illustrate an exemplary representation of general arrangement of the hybrid drive system in a rear wheel drive vehicle, in accordance with an embodiment of the present disclosure.

FIG. 2A illustrates a general arrangement of the hybrid drive system 106 of the rear wheel drive four wheeler from passenger side. The vehicle 100 includes a motor controller 112, a vehicle controller unit or programmable logic controller 122, an invertor and DC convertor 202, a battery 114, charging point 204, a Cable Harness (HV) 206, a gear lever 208, a hand brake 210, Cable Harness (LV) 212, a mode selector lever 214.

FIG. 2B illustrates a general arrangement of the hybrid drive system 106 of the rear wheel drive four wheeler from driver side. The vehicle 100 includes an ICE gear box 116, a break safety switch 218, a combined accelerator 220, a hand brake 210, a mode indicator 222, a neutral safety switch 224, a Cable Harness (LV) 226, a EV Key Switch 228, a ICE Key Switch 230, a audio visual indication 232, a mode selector lever 214, a Cable Harness (HV) 206, a gear lever 208.

FIG. 2C illustrates a general arrangement of the hybrid drive system 106 of the rear wheel drive four wheeler from under side. The vehicle 100 includes a motor controller 112, a vehicle controller unit or programmable logic controller 122, an invertor and DC convertor 202, a common output driveshaft (propeller shaft) 236, rear axle differential 238, an input driveshaft 312, ICE gear box 116, Cable Harness (LV) 226, Mode shifter 234, Battery 114, Cable Harness (HV) 206.

In an embodiment, FIG. 2A indicates location of the motor controller 112. A 1k ohm pre charging resistor is added across the mains contactor. Similarly, 1K ohm resistor is also added across the key switch for electric mode. Magnetically coupled accelerator 220 interacts with the mode selector lever 214 to provide desired speed control. The motor controller 112 provides proportionate power as per the torque speed demand as directed by the combined accelerator 220. A vehicle controller unit 122 is operatively connected to the motor controller 112 and the IC engine control unit 124. Thermistor control is provided internally through the motor controller 112 for the protection of the electric motor 108 winding from over-heating during rotor lock situation. The break safety switch 218 (also interchangeably referred as safety interlock switch) prevents accidental running of motor while brakes are engaged. The brake pedal is used to actuate the break safety switch 218.

In another embodiment, when the vehicle 100 is enabled to run in electric mode, the gearbox 116 connected to the IC engine assembly 118 must remain in “neutral mode”. This action has to be a foolproof system and is obtained by keeping the gear changing lever in a “neutral” position. A neutral safety switch 224 prevents activation of electric mode if the gear lever is not in the neutral position. Thus, protection interlocks are achieved. Further, the motor controller 112 provides a regeneration mode to conserve the free-wheeling rotational energy of the driven wheels and also to regenerate during braking done, thereby charging the batteries. Thus, this action is capable to further add extra miles as a result of regeneration. Further, the two independent electric key switches 228 and 230 are provided to isolate electric and engine mode. Speed and other display parameters are shown on custom build instrument cluster known as audio visual indication 232. The custom build cable harness 206 is provided for the power and control circuits and regeneration circuit of the motor controller 112, the combined accelerator 220, brake safety switch interlock 218, neutral gear safety switch 224, charging circuit and vehicle operations.

In an embodiment, the electric power is derived from the battery 114, or the hydrogen fuel cell stack mounted on the chassis frame of the vehicle 100 under the passenger or cargo compartment. Thereby, the new additions are maintained within the bodyline of the vehicle 100 and preserving the center of gravity of the vehicle 100 as low to the ground as possible for better dynamic behavior and balancing. The charging point 204 is located at a very convenient and easily accessible point on the vehicle 100 and charging is done by an external battery charger. A three-phase charging adapter is also provided to aid in the fast charging of the vehicle 100.

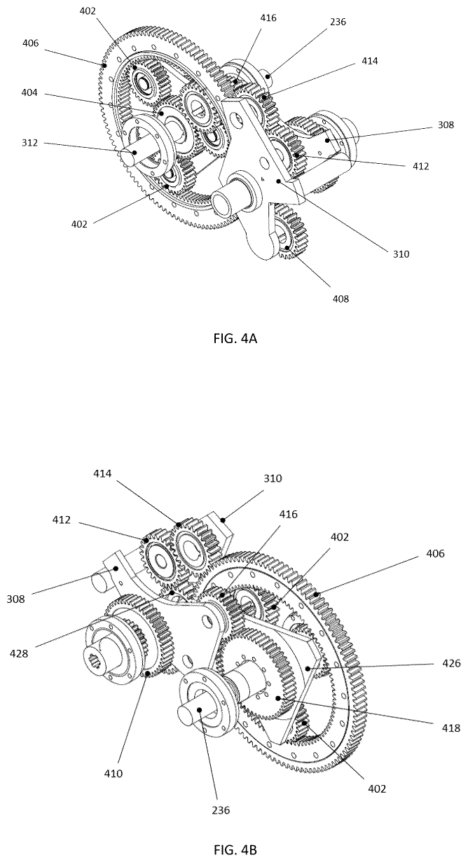

FIG. 3 illustrates an exemplary representation of general arrangement of the hybrid drive system comprising the hybrid drivetrain assembly and the electric motor, in accordance with an embodiment of the present disclosure.

In an embodiment, the hybrid drive system 106 majorly comprises of the hybrid drivetrain assembly 110 and the electric motor 108 as shown in FIG. 3. The input driveshaft 312 connects the output of the IC engine gearbox 116 with the hybrid drivetrain assembly 110. Thus, the output of the IC engine powerpack 500 is transmitted to the hybrid drivetrain assembly 110 by the input driveshaft 312. The hybrid drivetrain assembly 110 performs the dual role of combining the drives and individually transmitting the drives from the two powertrains-the IC engine powertrain and the Electric motor drive powertrain. The common output driveshaft 236 (also referred as propeller shaft) transmits the output of the hybrid drivetrain assembly 110 to the rear axle differential unit 238 and then onto the rear wheels 104. The hybrid drivetrain assembly 110 and the electric motor 108 can be located as a single module mounted on the chassis frame of the vehicle between the output of the gearbox 116 of the IC engine powerpack 500 and the differential 238 of the rear axle.

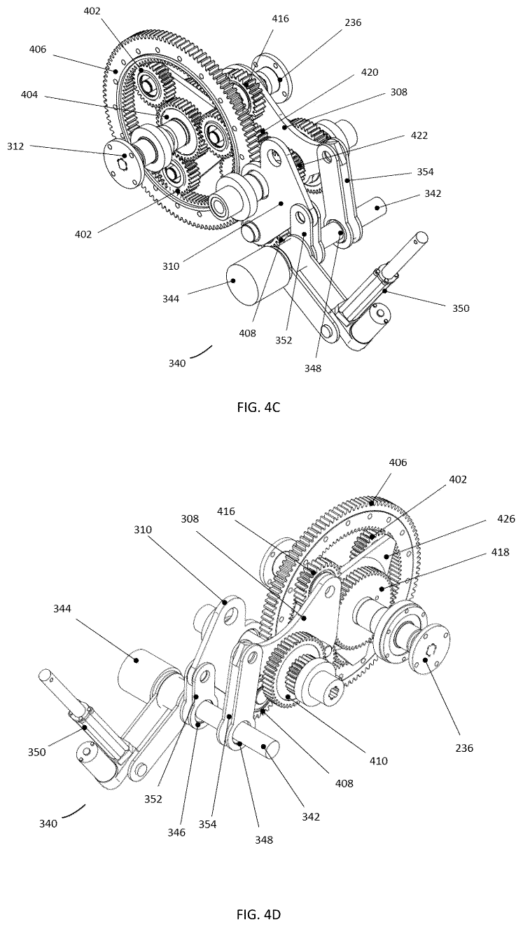

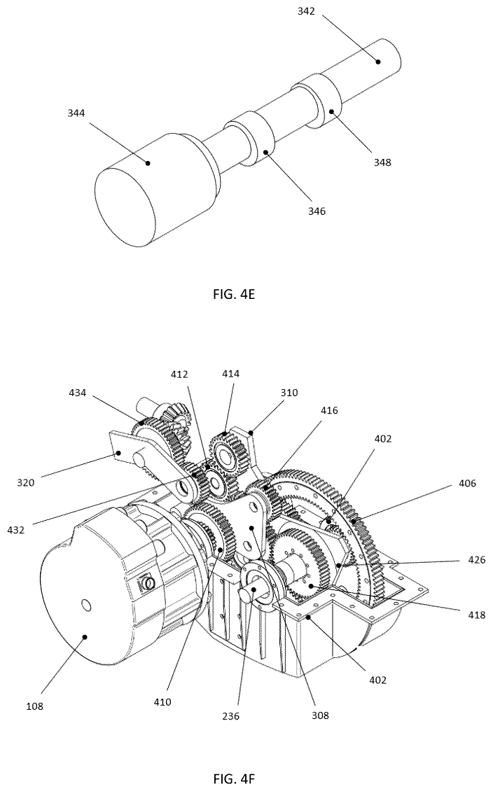

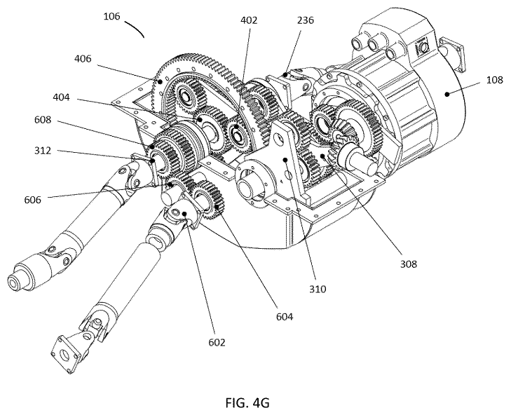

FIG. 4A to 4G illustrates an exemplary representation of general arrangement of the hybrid drivetrain assembly comprising the epicyclic geartrain assembly and the mode controller mechanism, in accordance with an embodiment of the present disclosure.

FIGS. 4A and 4B illustrate the epicyclic geartrain assembly 130 and the mode controller mechanism 140 from the engine side and electric motor side respectively. The epicyclic geartrain assembly 130 consists of a set of planet gears 402, a sun gear 404, a ring gear 406 and planet carrier 426. The electric motor shaft is connected to pinion 410, which then transmits the electric motor power to the epicyclic geartrain assembly through series of pinion gears. Further, the mode controller mechanism 140 includes common output driveshaft 236, a set of locking gears 408 and 416, a set of multi-plate clutches 462 and 464, a first set of pinion gears 418, 420 and 422 for transmitting electric motor power to planet carrier 426, a second set of pinion gears 412, 414 and 428 for transmitting electric motor power to ring gear 406. The pinion gear 418 is mounted to the planet carrier 426. The sun gear 404 receives the electric drive torque from the electric motor shaft through the planet gears 402 or the ring gear 406 thus having two torque-speed ratios. Also, the sun gear 404 receives the IC engine torque from the IC engine powerpack 500 from the input driveshaft 312. The sun gear 404 transmits the individual or combined torque to the common output driveshaft 236.

FIGS. 4C and 4D illustrate the epicyclic geartrain assembly 130 and the mode controller mechanism 140 with the electric eccentric & rocker mechanism (340) from engine side and the electric motor side respectively, in accordance with an embodiment of the present disclosure. The mode controller mechanism 140 in accordance with an embodiment of the present disclosure consists of a pair of control levers 308 & 310 that enable locking and unlocking of at least one of the planet carrier (426), the ring gear (406) and the sun gear (404) of the epicyclic geartrain assembly (130). The first set of pinion gears, the second set of pinion gears and the set of locking pinion gears are moved in different positions by the control levers 308 and 310 thereby activating the different modes of the hybrid drive system 106. Further the mode controller mechanism 140 consists of an electrically operated eccentric and rocker mechanism 340 to move the pair of control levers 308 & 310 to different positions. The electrically operated eccentric and rocker mechanism 340 comprises a pair of rocker arms 352 & 354 that are connected to the control levers 310 & 308 respectively. A shaft 342 is provided that has eccentrics 346 & 348 on which are mounted the pair of rocker arms 352 & 354 respectively. FIG. 4E shows the detailed view of the shaft 342. The electric motor 344 rotates the shaft 342 and an electric actuator 350 is also provided that can lock and prevent rotation of the shaft 342. On receiving the necessary command signal for changing the driving modes from the programmable logic controller 122, the electric motor 344 rotates the shaft 342 in the desired direction such that the rotation of the eccentrics 346 & 348 causes the rockers 352 & 354 to move the control levers 310 & 308 to different positions to enable the different driving modes. The electric actuator 350 locks the shaft 342 and prevents it from rotating once the desired position of the control levers is achieved. The desired signal for the electric actuator 350 is also given by the programmable logic controller 122. The design of the eccentrics 346 & 348 is such that it ensures that no more than one element of the epicyclic geartrain assembly 130 can be locked at a time.

In an embodiment, as shown in FIG. 4F the hybrid drivetrain assembly 110 for the two torque-speed ratios for electric drive is in conjunction with the Power Take-Off (PTO) mechanism. The levers 308 and 310 lock and unlock the elements of the epicyclic geartrain assembly 130. The lever 320 engages and disengages the PTO mechanism from the electric drive using the pinion gear 432 that engages with the motor pinion 410. The electric motor 108 power is transmitted to the hybrid drivetrain assembly by connecting the motor shaft to motor pinion 410.

In an embodiment, as shown in FIG. 4G the hybrid drive system 106 is implemented in an all-wheel drive or four-wheel drive vehicle. The FIG. 4G shows one such representative arrangement of the hybrid drivetrain assembly 110 implemented in an all-wheel drive or four-wheel drive vehicle. The set of gears 604, 606 and 608 are used to transfer the drive from the IC engine powerpack 500 and the drive from the electric motor 108 in a combined or individual manner using the hybrid drivetrain assembly 110 to the drive shaft 602. The drive shaft 602 transfers drive to the front axle of the vehicle. It is possible to combine various available all-wheel drive or four-wheel drive mechanisms together with the hybrid drive system 106.

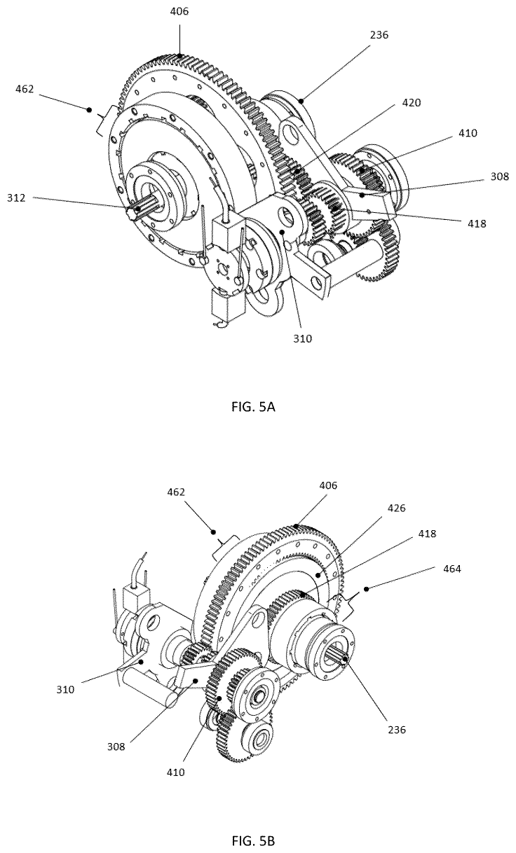

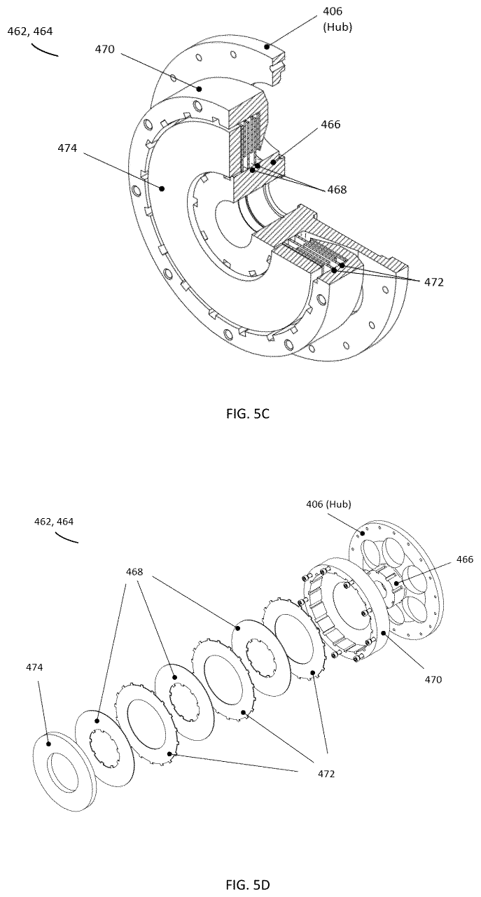

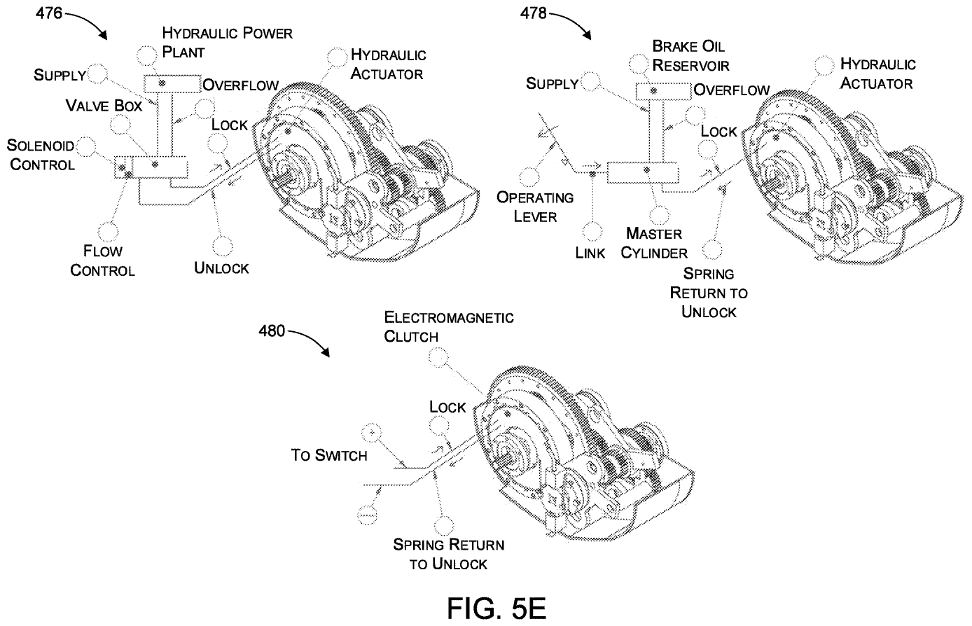

FIG. 5A to 5D shows another embodiment of the mode controller mechanism 140 comprising the multi-plate clutch arrangement that can be used as an alternate arrangement for locking and unlocking of the ring gear 406 and planet carrier gear 418 of the epicyclic geartrain 130. The mode controller mechanism 140 in accordance with an embodiment of the present disclosure consists of the first multi-plate clutch 462 and the second multi-plate clutch 464 that enable the locking and unlocking of the ring gear 406 and the planet carrier gear 418 respectively. The first multi-plate clutch unit 462 locks and unlocks the ring gear 406 and the second multi-plate clutch unit 464 locks and unlocks the planet carrier 426 by locking and unlocking the pinion gear 418. FIG. 5C shows a detailed cut-away and FIG. 5D shows an exploded view of the representative multi-plate clutch unit used. The inner hub 466 is mounted to the ring gear 406 and the gear 418 of the planet carrier 426. The inner friction plates 468 are operatively connected to this inner hub 466 and rotate with the ring gear 406 or the pinion gear 418. The outer hub 470 is fixed to the hybrid drive system housing and is stationary. The outer friction plates 472 are operatively connected to this outer hub 470. When the plunger 474 of the clutch units is actuated, the inner 468 and outer 472 friction plates are compacted against each other thereby slowing down the inner hubs 466 and thus slowing down the gears 406 or 418 and eventually stop the gears 406 or 418 from rotating. The actuation of plunger 474 is done by using at least one of the hydraulic mechanism 476, the linkage mechanism 478 and an electro-magnetic arrangement 480. FIG. 5E shows simple representative sketches of such different mechanisms for actuation of the multi-plate clutch. By releasing the clutch units, the inner 468 and outer 472 friction plates are no longer compacted against each other and hence the inner hubs 466 and hence the gears 406 or 418 are free to rotate. The multi-plate clutch units 462 and 464 thereby provide the necessary locking and unlocking of the ring gear 406 and the planet carrier 426 respectively thus providing the actuation of different driving modes of the hybrid drive system 106.

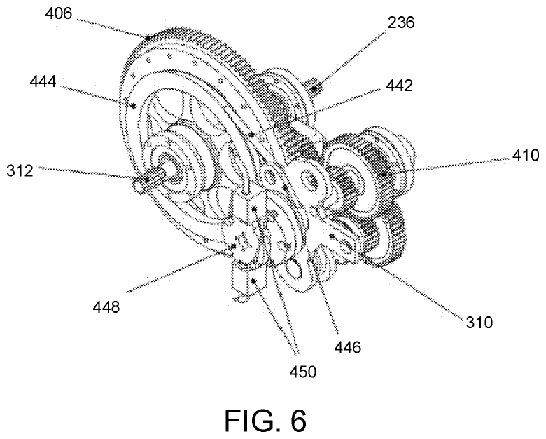

FIG. 6 shows another embodiment of the mode controller mechanism 140 comprising the bandbrake system that can be used as an alternate arrangement for locking and unlocking of the ring gear 406 and planet carrier gear 418 of the epicyclic geartrain 130. The band brake system consists of the brake band 442 and the hub 444 connected to the ring gear 406 or the pinion gear 418. The bell crank lever 446 moves in the desired location to tighten or loosen the band 442 on the hub 444 to lock or unlock the ring gear 406 or pinion gear 418 based upon the required operation to enable the different driving modes. This movement of the bell crank lever 446 is enabled by a spring-loaded plunger locking arrangement 448 operated by a cable system 450. The band brake system, the multi-plate clutch mechanism and the locking pinion gears with control levers can be used in conjunction or individually to get the desired locking and unlocking of the ring gear 406 and the planet carrier 426 of the epicyclic geartrain assembly 130 to enable the different driving modes of the hybrid drive system 106.

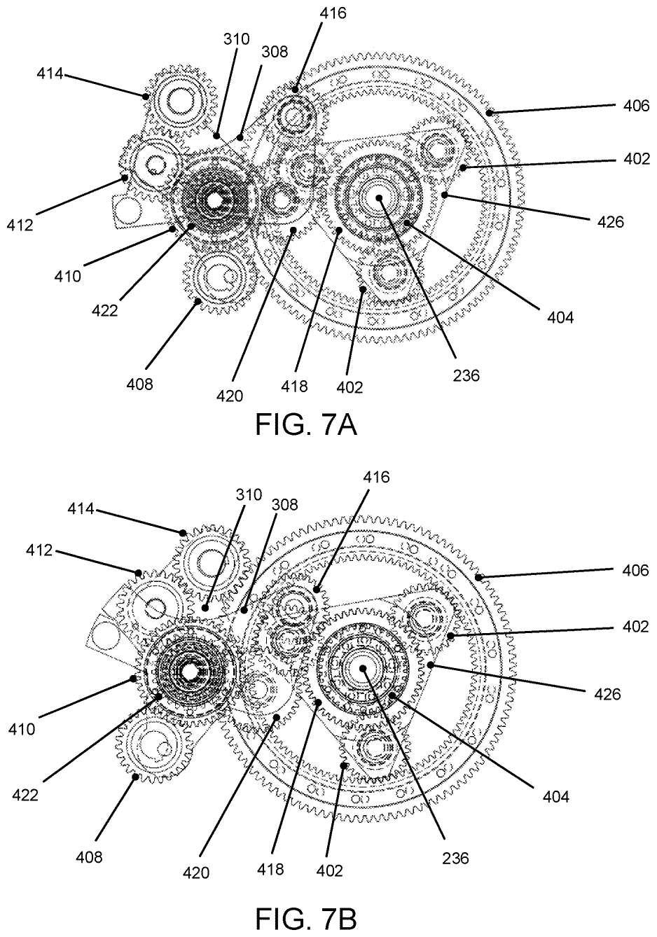

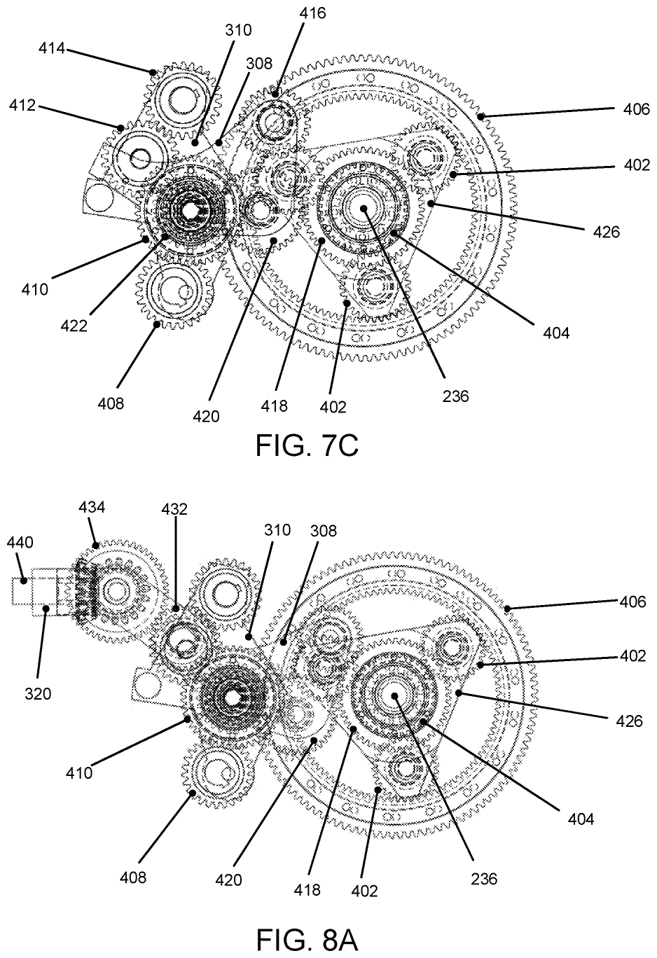

FIGS. 7A, 7B, and 7C illustrate the mode controller when in single mode, a second torque-speed gear ratio for electric mode, combined mode respectively, and in accordance with an embodiment of the present disclosure.

In an embodiment, FIG. 7A illustrates the epicyclic gear train assembly 130 and mode controller mechanism 140 when in a first torque-speed gear ratio during the electric mode. In this mode, the ring gear 406 is locked by pinion 408 and the planet carrier 426 is unlocked by the mode controller mechanism 140. Alternatively, the ring gear 406 can be locked by the first multi-plate clutch 462 of the mode controller mechanism 140. The drive from the electric motor 108 is transmitted to the hybrid drivetrain assembly 110 through the motor pinion 410. This drive from the electric motor 108 is then transmitted to the planet carrier 426 of the epicyclic geartrain through a set of pinion gears 422, 420 and 418. The torque from the electric motor 108 is thus transmitted to the planet carrier 426 and through the epicyclic geartrain 130 to the sun gear 404. This drive is then transmitted further by the sun gear 404 to the common output driveshaft 236 and then onto the rear axle and the wheels 104. For the IC engine mode, the electric motor 108 power is switched off and both the planet carrier 426 and the ring gear 406 of the epicyclic geartrain 130 are unlocked. The power from the IC engine powerpack 500 is sent through the sun gear 404 of the epicyclic drivetrain 130 to the common output driveshaft 236 and then onto the rear axle and the wheels 104.

In an embodiment, FIG. 7B illustrates the epicyclic geartrain assembly 130 and mode controller mechanism 140 when in second torque-speed gear ratio during electric mode. In this mode, the pinion 416 locks the planet carrier 426 by locking the pinion gear 418 and the ring gear 406 is unlocked by the mode controller mechanism 140. Alternatively, the planet carrier 426 can be locked by locking the pinion gear 418 using the second multi-plate clutch 464 of the mode controller mechanism 140. The drive from the electric motor 108 is transmitted to the hybrid drivetrain assembly 110 through the motor pinion 410. This drive from the electric motor 108 is then transmitted to the ring gear 406 of the epicyclic gear train 130 through a set of pinion gears 414, 412 and 428. The torque from the electric motor 108 is thus transmitted to the ring gear 406 and through the epicyclic geartrain 130 to the sun gear 404. This drive is then transmitted further by the sun gear 404 to the common output driveshaft 236 and then onto the rear axle and the wheels 104.

FIG. 7C illustrates the epicyclic geartrain assembly 130 and mode controller mechanism 140 in combined mode, where the levers 308 and 310 are moved in a position to the planet carrier 426 to be unlocked and the ring gear 406 to stay locked or unlocked. The torque from the electric motor 108 is transmitted to the planet carrier 426 and then to the sun gear 404. Additionally, the sun gear 404 also receives the IC engine torque from the gearbox 116 through the input driveshaft 312. The unlocked ring gear 406 allows the sun gear 404 to adjust to the torque being transmitted by both the electric motor 108 and the IC engine assembly 118 at the same time.

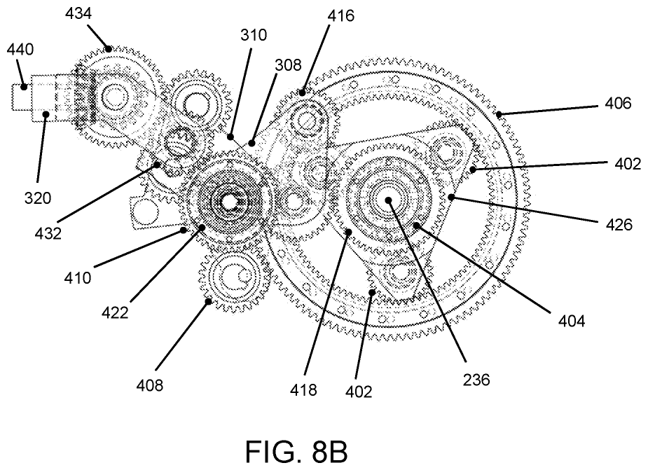

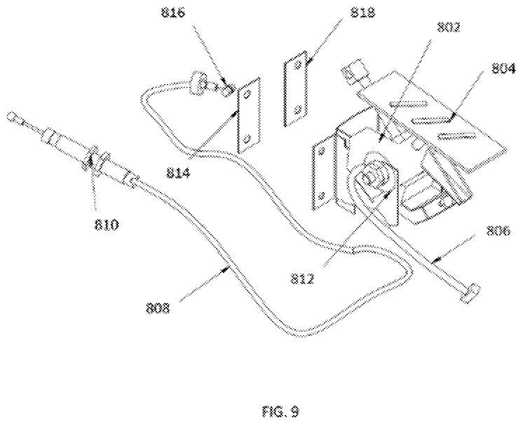

FIGS. 8A and 8B illustrate the hybrid drive system with a Power Take-off Option (PTO).

In an embodiment, FIG. 8A illustrates how the Power Take-off option to derive auxiliary power is implemented in the hybrid drive system. The electric motor drive 108 is transmitted to the hybrid drivetrain assembly 110 by the motor shaft connected to the pinion 410. The PTO lever 320 is moved in position such that the pinion 432 is in mesh with motor pinion 410. The electric motor drive is thus transmitted through the pinion 432, 434 and the set of bevel gears 436 & 438 to the PTO output shaft 440. The pinion gear 420 is out of mesh with the planet carrier pinion 418. The electric motor drive is thus used to drive the PTO operated accessories while there is no drive transmitted from the electric motor 108 to the epicyclic geartrain assembly 130 and hence the common output driveshaft 236 and wheels of the vehicle such that the PTO accessories can be operated while the vehicle is stationary or not driven by electric power.

In another embodiment, FIG. 8B illustrates how the Power Take-off option to derive auxiliary power is implemented in the hybrid drive system while the vehicle is also driven under electric power through the hybrid drive system. The electric motor drive 108 is transmitted to the hybrid drivetrain assembly 110 by the motor shaft connected to the pinion 410. The PTO lever 320 is moved in position such that the pinion 432 is in mesh with motor pinion 410. The electric motor drive is thus transmitted through the pinion 432, 434 and the set of bevel gears 436 & 438 to the PTO output shaft 440. The pinion gear 420 is in mesh with the planet carrier pinion 418. The electric motor drive is thus used to drive the PTO operated accessories while there is electric motor drive being transmitted from the electric motor 108 to the epicyclic gear system and hence the propeller shaft 236 and wheels of the vehicle such that the PTO accessories can be operated while the vehicle is being driven by electric power.

FIG. 9 illustrates an exemplary representation of the combined electro-mechanical accelerator 220 of the vehicle 100. The electro-mechanical accelerator 220 may include an accelerator fixture 802, which is used to fixedly mount the accelerator pedal 804 within the vehicle 100. The combined accelerator 220 serves as the accelerator for both the IC engine assembly 118 and the electric motor 108, providing ease of operation for the driver of the vehicle 100, allowing them to maintain their driving habits. The accelerator pedal 804 may be configured to operate both the electric and internal combustion engine accelerators simultaneously. A mechanical cable 808 operates a mechanism that provides the accelerator function for the IC engine assembly 118. The combined accelerator 220 may also include a connecting cable 806, which is operatively connected to the electric motor 108, and a magnetic coupling and sensor 812 that transmit a signal to the motor controller 112 based on the movement of the pedal 804, thereby providing the accelerator function for the electric motor 108. The combined accelerator 220 may include accelerator supports 814 and 818 to ensure proper fitment within the vehicle 100. Additionally, the combined accelerator 220 may feature a mechanical adjuster 810 adapted to adjust the positioning of the mechanical cable 808, which is coupled to the IC engine assembly 118, and a cable stretcher 816 configured to connect to a lever of the accelerator pedal 804. Thus, hybrid accelerator operation can be easily achieved through the common accelerator 220. The common accelerator 220 is configured with an optimized phase lag, allowing the IC engine assembly 118 to lag behind the electric motor 108 when the driver operates the accelerator pedal 804 while driving in combined mode.

In an exemplary embodiment, the hybrid electric drive system 106 of the present invention synchronizes and transfers the torque generated by the two powertrains to the wheels of the vehicle 100. The hybrid electric drive system 106 serves the dual role of allowing the drive from each powertrain to be transmitted individually to the wheels of the vehicle 102/104 as demanded by the user, and of combining the drives from each powertrain and seamlessly transmitting them to the wheels of the vehicle 102/104 as required. The hybrid electric drive system 106 enables the true addition of the capabilities of the two distinct powertrains, preventing the splitting of the torque generated by either powertrain and instead adding the torque to meet the vehicle's load demand by synchronizing the drives. This ensures the best utilization of the torque-speed characteristics of both powertrains. The hybrid electric drive system 106 makes unique use of the epicyclic geartrain assembly 130 in combination with the mode controller 140 to provide the necessary synchronization between the drives from the two powertrains. When the user operates the hybrid electric drive system 106 in the combined mode, the epicyclic geartrain assembly 130 is uniquely operated by the mode controller 140 to take advantage of the torque-speed characteristics of the individual powertrains. The combined accelerator conveys the user's demand to the hybrid electric drive system 106, and based on the total torque demand of the vehicle 100, the combination of the two powertrains is managed to deliver the required torque with the best possible efficiency.

The combined accelerator 220 is equipped with an optimized phase lag that allows the IC engine assembly 118 to lag behind the electric motor 108, taking advantage of the high initial starting torque of the electric motor 108 during the combined mode of operation. In this mode, the combined accelerator 220 is configured to allow the electric motor 108 to speed up earlier while the IC engine assembly 118 is still at idle speed, based on the programmable phase lag. The high starting torque of the electric motor 108 propels the vehicle 100 by providing the necessary torque up to a first programmable threshold speed of the vehicle. As the speed of the vehicle increases above this first programmable threshold speed, the IC engine assembly 118 begins providing the necessary torque to continue propelling the vehicle 100 as directed by the microcontroller 122. The epicyclic geartrain assembly 130 and the mode controller mechanism 140 ensures a seamless addition of the two drives, with the electric motor 108 assisting the IC engine assembly 118 to propel the vehicle 100, while keeping the IC engine assembly 118 operating in its highest efficiency zones. At a second programmable threshold speed, the IC engine assembly 118 operates more efficiently than the electric motor 108. At this point, the controller 122 shuts off the electric motor 108, and only the IC engine assembly 118 propels the vehicle 100. If the speed of the vehicle 100 drops below the second programmable threshold but remains above the first, the controller 122 turns the electric motor 108 back on to assist the IC engine assembly 118 in propelling the vehicle 100. If the vehicle speed falls below the first programmable threshold, the controller 122, with the help of the combined accelerator 220, enables the electric motor 108 to provide the necessary drive to propel the vehicle 100, while the IC engine assembly 118 operates at idle speed. Thus, during the combined mode of operation, the chip-based microcontroller 122, along with the combined accelerator 220, enables propulsion of the vehicle 100 while ensuring the use of the highest efficiency zones of either powertrain.

Although this present invention has been described herein with respect to a number of specific illustrative embodiments, the foregoing description is intended to illustrate, rather than to limit the invention. Those skilled in the art will realize that many modifications of the illustrative embodiment could be made which would be operable. All such modifications, which are within the scope of the claims, are intended to be within the scope and of the present invention.

### ADVANTAGES OF THE PRESENT DISCLOSURE

The present disclosure provides an efficient mechanism to build low emissions, fuel-saving hybrid electric drive system that can operate independently and in combined mode. Such a system would improve the fuel economy significantly and this would also mean a significant reduction in CO2 emissions per km.

The present disclosure provides a hybrid electric drive system that increases the life expectancy of the vehicle.

The present disclosure provides a hybrid electric drive system that provides a cost-effective solution to reduce the emissions from vehicles.

The present disclosure provides a hybrid electric drive system that helps in conserving the usage of fossil fuel thereby helping in reducing the import bills of such fuels for the nation.

The present disclosure provides a hybrid electric drive system which helps to re-purpose/upcycle the existing IC engine driven vehicle architectures into such cost-effective, low emissions, inclusive, consumer friendly mobility solutions; and also reduce the design and manufacturing costs for manufacturers.

Using this invention, OEM's can either manufacture new PHEV or FC-HEV variants of their existing ICE vehicles in the portfolio, or can promote the retrofit conversion solutions through their authorized service/dealer network, both options offering huge additional revenue opportunities, besides leading to substantially higher green miles and achieving better CAFE regulatory norms. On a national level, the resulting savings of imported fossil fuels and the consequential benefits to national economy is certainly a huge advantage.

The present invention can be extremely beneficial for the consumers because it offers them the opportunity to recover substantial initial cost of vehicle due to reduced operating costs over the lifespan of vehicle. Since, the employment will be retained and can be grown further across ICE/EV/FCEV supply chains and multiple fuels eligible to be used, this invention is extremely inclusive for the economy.

Thus, the present invention would be a win-win solution for all the stakeholders such as Government, OEM, Consumers, Economy and Environment that we all have shared interests in.

1. A hybrid drive system, said hybrid drive system comprising:
an electric motor;
a hybrid drivetrain assembly;
a common output driveshaft that transmits power from the hybrid drive system to the rear axle of the vehicle to drive the set of wheels;
wherein the hybrid drive system is configured between an IC engine gearbox and the rear axle of the vehicle for a rear wheel drive or an all-wheel drive vehicle;
wherein the hybrid drive system enables three different and independent driving modes, the three driving modes comprising: an IC engine mode with drive to the wheels from the IC engine power pack, an electric mode with drive to the wheels from the electric motor, and a combined mode with drive to the wheels collectively from the IC engine power pack and the electric motor;
wherein the hybrid drivetrain assembly comprises an epicyclic geartrain assembly and mode controller mechanism that enable engagement and disengagement of the electric motor drive with the drive from IC engine power pack; and
wherein the mode controller mechanism of the hybrid drivetrain assembly comprises at least one of a pair of control levers that move to different positions, a multi-plate clutch arrangement and a band brake system to enable locking or unlocking of at least one of the planet carrier, the ring gear and the sun gear of the epicyclic geartrain assembly enabling a single or multiple torque-speed ratios during the drive from the electric motor in a pure electric mode or in a combined mode of operation and the IC engine driving mode; and
wherein the mode controller mechanism of the hybrid drivetrain assembly comprises an electrically operated eccentric and rocker mechanism to move the pair of control levers to different positions to enable the different driving modes.

2. The hybrid drive system as claimed in claim 1, wherein the hybrid drivetrain assembly allows output to be taken from a sun gear of the epicyclic geartrain assembly and input to be given to at least one of planet carrier or a ring gear of the epicyclic geartrain;
wherein the power from both the IC engine power pack and the electric motor is transmitted to the sun gear such that the sun gear transmits the power to the common output driveshaft;
wherein the hybrid drivetrain assembly comprises a first series of pinion gears that transmit electric motor power to planet carrier of the epicyclic gear system and a second series of pinion gears that transmit electric motor power to ring gear of the epicyclic geartrain; and
wherein a first locking pinion gear locks and unlocks the ring gear of the epicyclic geartrain assembly, and a locking pinion gear locks and unlocks the planet carrier of the epicyclic gear train based upon the required operation to enable the different driving modes and the pinion gears and are mounted on the control levers.

3. The hybrid drive system as claimed in claim 1, wherein the electrically operated eccentric and rocker mechanism of the mode controller mechanism comprises:
a pair of rocker arms and that are connected to the control levers and respectively;
a shaft that has eccentrics and the pair of rocker arms and are mounted on these eccentrics and respectively;
an electric motor that rotates the shaft;
an electric actuator that locks and unlocks the rotation of the shaft on receiving the necessary command signals;
wherein, on receiving the necessary command signal, the electric motor rotates the shaft in the desired direction such that the rotation of the eccentrics causes the rockers to move the control levers to different positions to enable the different driving modes, and wherein the electric actuator locks the shaft once the desired position of the control levers is achieved.

4. The hybrid drive system as claimed in claim 2, wherein for the electric mode, the planet carrier of the epicyclic geartrain is unlocked, the electric motor power is transmitted to the planet carrier through a first series of pinion gears of the epicyclic geartrain and mode controller, and the ring gear is locked such that, the power from the electric motor is sent through the epicyclic geartrain to the sun gear and then onto the common output driveshaft and the electric mode is enabled.

5. The hybrid drive system as claimed in claim 2, wherein, for a second torque speed gear ratio in the electric mode, the ring gear of the epicyclic geartrain is unlocked, the electric motor power is transmitted to the ring gear through the second series of pinion gears of the epicyclic geartrain and mode controller, and the planet carrier is locked such that, the power from the electric motor is sent through the epicyclic geartrain to the sun gear and then onto the common output driveshaft and the second torque speed gear ratio in electric mode is enabled.

6. The hybrid drive system as claimed in claim 2, wherein for the IC engine mode, the planet carrier of the epicyclic geartrain is unlocked with the electric motor being switched off and the ring gear of the epicyclic geartrain is also unlocked such that, the power from the IC engine powerpack is sent to the common output driveshaft through the sun gear and the IC engine mode is enabled.

7. The hybrid drive system as claimed in claim 2, wherein for combined mode, the planet carrier of the epicyclic gear train is unlocked, power from the electric motor is transmitted to the planet carrier, and the ring gear is locked or unlocked such that unlocking of the ring gear allows the sun gear to adjust to the power being transmitted from both IC engine power pack and electric motor.

8. The hybrid drive system as claimed in claim 1, wherein the mode controller mechanism of the hybrid drivetrain assembly comprises a first multi-plate clutch arrangement that locks and unlocks ring gear and a second multi-plate clutch arrangement that locks and unlocks the planet carrier of the epicyclic geartrain assembly enabling a single or multiple torque-speed ratios during the drive from the electric motor in a pure electric mode or in a combined mode of operation and the IC engine driving mode.

9. The hybrid drivetrain assembly as claimed in claim 8, wherein the first multi-plate clutch arrangement and second multi-plate clutch arrangement is operated using at least one of the hydraulic mechanism, the linkage mechanism and an electro-magnetic arrangement.

10. The hybrid drivetrain assembly as claimed in claim 8, wherein the mode controller comprises at least one of the programmable logic operatively coupled to provide signals and a mechanical cable operated assembly operatively coupled to a hydraulic mechanism, a linkage mechanism or an electro-magnetic arrangement, to enable the different driving modes.

11. The hybrid drivetrain assembly as claimed in claim 1, wherein the mode controller mechanism comprises a first band brake system that locks and unlocks ring gear, and a second band brake system that locks and unlocks the planet carrier of the epicyclic gear train based upon the required operation to enable the different driving modes.

12. The hybrid drivetrain assembly as claimed in claim 11, wherein each of the band brake system comprises of the brake band, the hub connected to the gear and a bell crank lever. A spring-loaded plunger locking arrangement operated by a cable system enables the bell crank lever to move in the desired location to tighten or loosen the band on the hub to lock or unlock the ring gear or planet carrier based upon the required operation to enable the different driving modes.

13. The hybrid drive system as claimed in claim 2, wherein the hybrid drive system further enables a regeneration mode that allows a transfer of power from sun gear to planet carrier with the ring gear locked or unlocked, thereby resulting in different levels of regeneration to allow a battery pack to be recharged, depending on the state of charge.

14. The hybrid drive system as claimed in claim 1, wherein, by including more than one epicyclic gear train assembly in the hybrid drivetrain assembly, multiple torque speed gear ratios could be made possible in the electric mode.

15. The hybrid drive system as claimed in claim 2, wherein to enable the power take-off, the lever is moved in a position such that the pinion gear gets engaged with motor pinion and the pinion gear is taken out of mesh with pinion gears. The electric motor power is then transmitted to the power take-off output shaft with the electric motor power not being transmitted to the epicyclic gear train assembly.

16. The hybrid drive system as claimed in claim 2, wherein to enable the power take-off, the lever is moved in a position such that the pinion gear gets engaged with motor pinion and the pinion gear is kept in mesh with pinion gears. The electric motor power is then transmitted to the power take-off output shaft with the electric motor power also being transmitted to the epicyclic gear train assembly to allow the vehicle to be driven by the electric motor power.

17. A vehicle comprising the hybrid drive system as claimed in claim 1.

18. A vehicle having a transfer case with a four-wheel drive or all-wheel drive option comprising the hybrid drive system as claimed in claim 1.

19. The hybrid drive system as claimed in claim 1, wherein the hybrid drive system enables—(i) conversion of IC engine vehicle into its plug-in hybrid electric vehicle variant or (ii) a production of a new plug-in hybrid electric vehicle;
wherein the IC engine is powered by at least one type of fuel such as diesel, petrol, CNG, LNG, ethanol and hydrogen; and
wherein the electrical energy to operate the electric motor is provided by at least one energy source such as a battery, a hydrogen fuel cells stack and an arrangement of ultra-capacitors.

20. The hybrid drive system as claimed in claim 1, wherein the hybrid drive system in a constrained design space of the prevalent ICE vehicle architecture enables conversion of the on-road ICE vehicle into its plug-in hybrid electric vehicle variant and then into a full electric vehicle variant in a phased manner.
